(19) United States
(12) Patent Application Publication
(10) Pub. No.: US 2012/0182934 A1
(43) Pub. Date: Jul. 19, 2012

(54) APPLICATION LAYER COMMUNICATION VIA AN INTERMEDIATE NODE

(76) Inventors: John Diachina, Garner, NC (US); Paul Schliwa-Bertling, Ljungsbro (SE); Gunnar Rydnell, Vastra Frolunda (SE)

(21) Appl. No.: 13/095,287

(22) Filed: Apr. 27, 2011

Related U.S. Application Data
(60) Provisional application No. 61/433,691, filed on Jan. 18, 2011.

(51) Int. Cl. H04W 4/00

(52) U.S. Cl. 370/328

(57) ABSTRACT

An intermediate node in a wireless communication system transmits application layer messages between first and second nodes. To do so, the intermediate node receives a request to activate a packet data protocol (PDP) context for the first node. The request, as generated by the first node, indicates the first node is capable of using a first protocol stack that excludes one or more particular layers included in a second protocol stack used by the second node. The intermediate node activates a PDP context for the first node in accordance with the request. The intermediate node thereafter forwards application layer messages supported by the activated PDP context between the first node and the second node, forwarding application layer messages destined for the first node in accordance with the first protocol stack and forwarding application layer messages destined for the second node in accordance with the second protocol stack.

### RELATED APPLICATIONS

This application claims priority from U.S. Provisional Patent Application No. 61/433,691, which was filed on 18 Jan. 2011 and is incorporated herein by reference in its entirety.

### TECHNICAL FIELD

The present application generally relates to application layer communication, and particularly relates to forwarding application layer communications between two nodes, where one of those nodes is capable of excluding one or more protocol layers used by the other node.

### BACKGROUND

Wireless communications are extending beyond traditional mobile voice and data devices. Unlike these traditional devices, Machine Type Communication (MTC) devices wirelessly communicate with little or no human intervention. For example, an application on an MTC device may autonomously collect and send data to a supporting MTC server via a wireless communication network. This autonomous machine communication broadens the reach of useful wireless services to include smart utility metering, inventory control, remote patient care, and many others.

The anticipated introduction of a large number of MTC devices in the near future will place a large capacity demand on wireless communication networks. Indeed, it is expected that MTC devices will far outnumber traditional, non-MTC devices operated by human users. And, more problematic than the sheer increase in the number of devices, current networks remain optimally designed for non-MTC devices.

For example, current networks subject MTC devices to rather elaborate procedures for sending and receiving application data. The procedures, while robust for handling non-MTC device use scenarios, require a significant amount of control signaling and header information to accompany the application data. This extensive control signaling and header information jeopardizes the ability of wireless networks to consistently offer sufficient capacity for both MTC devices and non-MTC devices.

### SUMMARY

Embodiments herein advantageously reduce the amount of control signaling and header information that must accompany application data when transporting that data between an MTC device and a supporting MTC server via an intermediate node in a wireless communication network. To do so, the embodiments exploit the relatively static nature of header information typical of an MTC device and avoid transporting such header information between the MTC device and the intermediate node. In this regard, the embodiments also incidentally extend to non-MTC devices with relatively static header information.

More particularly, in one or more embodiments, an intermediate node comprises a PDP context controller and a forwarding circuit. The PDP context controller is configured to receive a request to activate a packet data protocol (PDP) context for a wireless device. In doing so, the controller interprets or otherwise recognizes the request as indicating that the wireless device is capable of using a first protocol stack that excludes one or more particular layers included in a second protocol stack used by the application server. The PDP context controller is further configured to activate a PDP context for the wireless device in accordance with the request. The resulting activated PDP context thus supports routing of application layer messages between the wireless device and the application server via the intermediate node.

The forwarding circuit is configured to forward application layer messages supported by the activated PDP context between the wireless device and the application server. The forwarding circuit forwards application layer messages destined for the wireless device in accordance with the first protocol stack (e.g., by removing header information for the one or more particular layers), and forwards application layer messages destined for the application server in accordance with the second protocol stack (e.g., by adding header information for the one or more particular layers).

Correspondingly, a wireless device in one or more embodiments includes a PDP context controller. The PDP context controller is configured to generate a request requesting that the intermediate node activate a PDP context for supporting routing of application layer messages via the intermediate node. In generating this request, the controller 30 includes information in the request that indicates the wireless device is capable of using a first protocol stack that excludes one or more particular layers included in a second protocol stack used by the application server. Thereafter, the PDP context controller is configured to receive a response from the intermediate node indicating that the intermediate node has activated the requested PDP context. The controller is further configured to interpret or otherwise recognize the response as indicating that the intermediate node will indeed support the device's use of the first protocol stack by forwarding application layer messages destined for the device in accordance with the first protocol stack and forwarding application layer messages destined for the application server in accordance with the second protocol stack.

In this regard, the wireless device further comprises a transmission circuit. The transmission circuit is configured to send application layer messages supported by the activated PDP context toward the intermediate node using the first protocol stack. Such may entail excluding the one or more particular protocol layers despite actually having knowledge of some or all of the header information for those layers.

At least some of the header information for the one or more particular layers may be determined in conjunction with the PDP context activation procedure performed for the wireless device and maintained at the intermediate node. Such header information may include, for instance, the PDP address of the device. Other header information for the one or more particular layers (e.g., the PDP address of the application server) may also be received and maintained by the intermediate node in conjunction with the PDP context activation process. Still other header information (e.g., length and/or error detection fields) for the one or more particular layers may be dynamically determined by the intermediate node in conjunction with application layer messages sent after completion of the PDP context activation procedure.

In Enhanced General Packet Radio Services (EGPRS) embodiments, the intermediate node discussed above may comprise a serving GPRS support node (SGSN) or a gateway GPRS support node (GGSN), and the one or more particular layers include the User Datagram Protocol (UDP) and Internet Protocol (IP) layers, or UDP/IP.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication system that supports wireless transmission of application layer messages between a wireless device and an application server via an intermediate node, according to one or more embodiments.

FIG. 2 is a block diagram of an intermediate node that is configured to wirelessly transmit application layer messages between a wireless device an application server, according to one or more embodiments.

FIG. 3 is a block diagram of a wireless device that is configured to transmit application layer messages to an application server according to one or more embodiments.

FIGS. 4A and 4B are block diagrams of header information for User Datagram Protocol (UDP) and Internet Protocol (IP) layers according to some embodiments.

FIG. 5 is a block diagram of an Enhanced General Packet Radio Services (EGPRS) system that supports wireless transmission of application layer messages between a wireless device and an application server via an intermediate node, according to one or more embodiments.

FIGS. 6A and 6B are signaling and protocol stack diagrams of EGPRS embodiments wherein a serving GPRS support node (SGSN) serves as the intermediate node of FIG. 1.

FIGS. 7A and 7B are signaling and protocol stack diagrams of EGPRS embodiments wherein a gateway GPRS support node (GGSN) serves as the intermediate node of FIG. 1.

FIGS. 8A and 8B are signaling diagrams of EGPRS embodiments wherein a base station subsystem (BSS) assists with relaying of UDP/IP header information to an SSGN.

FIG. 9 is a logic flow diagram illustrating processing implemented by an intermediate node for wireless transmission of application layer messages according to one or more embodiments.

FIG. 10 is a logic flow diagram illustrating processing implemented by a wireless device for wireless transmission of application layer messages according to one or more embodiments.

### DETAILED DESCRIPTION

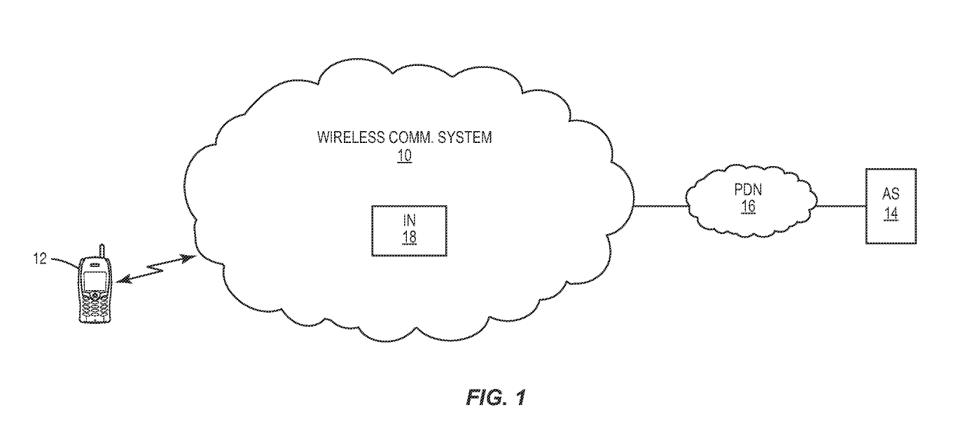

FIG. 1 illustrates a wireless communication system 10. This system 10 facilitates end-to-end communications between a wireless device (WD) 12 and an application server (AS) 14 connected to the system 10 via an external packet data network (PDN) 16, e.g., the Internet. Such end-to-end communications occur at a relatively high protocol layer referred to herein as an application layer, with the end-to-end communications consisting of the exchange of application layer messages between the WD 12 and AS 14.

In order to transport these application layer messages over the PDN 16, header information required by the packet data protocol (PDP) of the PDN 16 (e.g., the Internet Protocol, IP) must be added to the messages. This added header information forms the relatively lower protocol layer(s) referred to as the PDP layer(s) and includes, among other things, the source PDP address and the destination PDP address. For example, the PDP layer(s) added to an application layer message transported from the WD 12 to the AS 14 include header information that indicates the PDP address of the WD 12 as the source PDP address and the PDP address of the AS 14 as the destination PDP address. The WD 12 must therefore have a PDP address.

The WD 12 may be assigned a PDP address in conjunction with a so-called PDP context being activated for that WD 12. A PDP context for the WD 12 comprises a data structure that provides information required for the WD 12 to access the PDN 16, e.g., in terms of the specific PDP address of the network node used to access the PDN 16 (i.e. the access point name), the PDP address of the WD 12, the quality of service (QoS) information for the session, and the like. Activating a PDP context for the WD 12 thus refers to the process of creating this data structure, which is maintained for the duration of that PDP context, at the WD 12 as well as other nodes in the system 10.

Heretofore, a wireless device that sent an application layer message to an application server added the header information required at the PDP layer(s), based on the PDP context maintained at that device (including the source PDP address) and based on other information such as the desired destination PDP address associated with the application server. Because the wireless device retained control over the header information, the device could dynamically change the information as needed (e.g., to change the desired destination PDP address). However, the header information undesirably traversed the entire wireless communication system, adding to the bandwidth required to support application layer message transmissions over the radio interface. The same could be said for application layer messages sent in the opposite direction, from an application server to a wireless device.

Notably, embodiments herein exploit the fact that this header information remains relatively static for at least some types of WDs 12 (e.g., MTC devices) and avoid transporting the header information over the entire wireless communication system 10. To this end, an intermediate node (IN) 18 in the system 10 adds and removes the header information instead of the WD 12. This intermediate node 18 adds the header information for transport towards the AS 14 and removes the header information for transport towards the WD 12, based on a PDP context maintained at the intermediate node 18 and any other aspects of the header information previously received and maintained at the intermediate node 18. This way, the header information does not traverse any part of the system 10 between the WD 12 and the intermediate node 18, thereby reducing bandwidth requirements on the radio interface. And, as this header information is associated with the PDP layer(s), the WD 12 can transmit and receive application layer messages using a protocol stack that actually excludes those one or more protocol layers.

According to one or more embodiments, the WD 12 informs the intermediate node 18 that it is capable of using such a protocol stack in conjunction with requesting that the intermediate node 18 activate a PDP context. The intermediate node 18 can thereafter forward application layer messages supported by that PDP context accordingly.

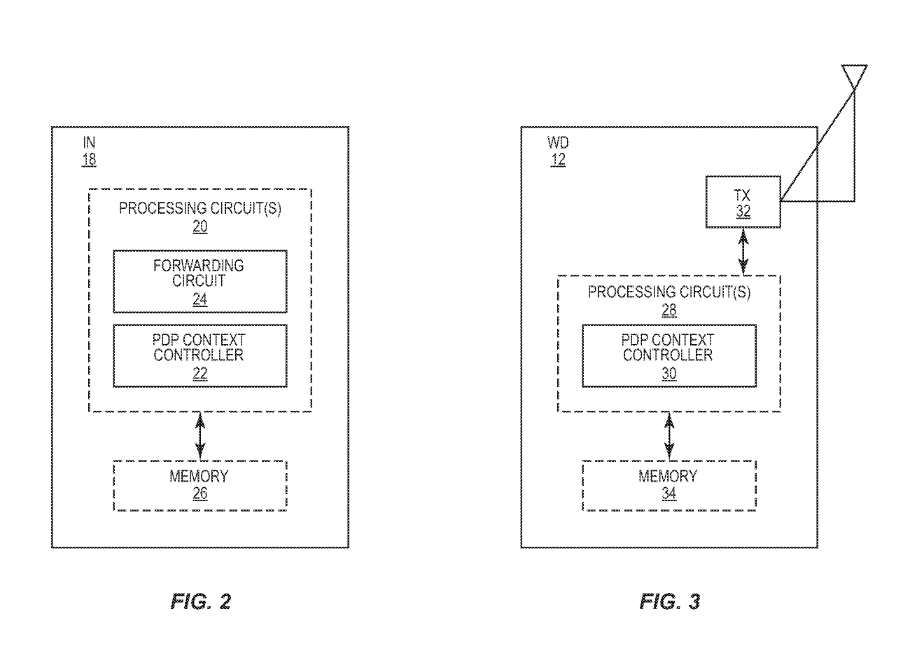

FIGS. 2 and 3 illustrate additional details of the intermediate node 18 and WD 12 according to such embodiments. As shown in FIG. 2, the intermediate node 18 comprises one or more processing circuits 20 which include a PDP context controller 22 and a forwarding circuit 24. The PDP context controller 22 is configured to receive a request to activate a PDP context for the WD 12. In doing so, the controller 22 interprets or otherwise recognizes the request as indicating that the WD 12 is capable of using a first protocol stack that excludes one or more particular layers (e.g., PDP layer(s)) included in a second protocol stack used by the AS 14. The PDP context controller 22 is further configured to activate a PDP context for the WD 12 in accordance with the request. The resulting activated PDP context thus supports routing of application layer messages between the WD 12 and the AS 14 via the intermediate node 18.

The forwarding circuit 24 is configured to forward application layer messages supported by the activated PDP context between the WD 12 and the AS 14. The forwarding circuit 24 forwards application layer messages destined for the WD 12 in accordance with the first protocol stack (e.g., by removing header information for the one or more particular layers), and forwards application layer messages destined for the AS 14 in accordance with the second protocol stack (e.g., by adding header information for the one or more particular layers).

Particularly with respect to forwarding application layer messages destined for the AS 14, the intermediate node 18 adds header information to those messages in the sense that it generates the one or more particular layers from the header information it maintains as a result of performing the PDP context activation procedure. The intermediate node 18 then adds the generated layers to the messages.

FIG. 3 correspondingly illustrates details of the WD 12. As shown in FIG. 3, the WD 12 comprises one or more processing circuits 28 that include a PDP context controller 30. The PDP context controller 30 is configured to generate a request requesting that the intermediate node 18 activate a PDP context for supporting routing of application layer messages via the intermediate node 18. The controller 30 also generates the request to indicate that the WD 12 is capable of using a first protocol stack that excludes one or more particular layers (e.g., PDP layer(s)) included in a second protocol stack used by the AS 14. Thereafter, the PDP context controller 30 is configured to receive a response from the intermediate node 18 indicating that the intermediate node 18 has activated the requested PDP context. The controller 30 is further configured to interpret or otherwise recognize the response as indicating that the intermediate node will indeed support the WD's use of the first protocol stack by forwarding application layer messages destined for the WD 12 in accordance with the first protocol stack and forwarding application layer messages destined for the AS 14 in accordance with the second protocol stack.

In this regard, the WD 12 further comprises a transmission circuit 32. The transmission circuit 32 is configured to send application layer messages supported by the activated PDP context toward the intermediate node 18 using the first protocol stack. Such may entail excluding the one or more particular protocol layers despite actually having knowledge of some or all of the header information for those layers.

Responsive to receiving application layer messages sent from the WD 12 in accordance with the first protocol stack, the intermediate node 18 adds header information for the one or more particular layers, for forwarding of those messages towards the AS 14 in accordance with the second protocol stack. At least some of the header information for the one or more particular layers may be determined as a result of the PDP context activated for the WD 12 and maintained at the intermediate node 18. Such header information may include, for instance, the PDP address of the WD 12. Other header information for the one or more particular layers (e.g., the PDP address of the AS 14) may be received by the intermediate node 18 in conjunction with the PDP context activation process. For example, in some embodiments, the WD 12 proactively sends such header information to the intermediate node 18 in the request for PDP context activation. In other embodiments, the WD 12 reactively sends the header information to the intermediate node 18 upon the intermediate node 18 requesting it. The intermediate node 18 may for instance request the header information from the WD 12 responsive to receiving the request for PDP context activation.

Still other header information for the one or more particular layers may be dynamically determined by the intermediate node 18. In some embodiments, for example, the intermediate node 18 dynamically determines the length of application layer messages it receives from the WD 12 and adds header information to the application layer messages based on that length. Additionally or alternatively, the intermediate node 18 dynamically determines an error detection field (e.g., a checksum) for ensuring the integrity of all or part of the message forwarded to the AS 14. The error detection field may for instance ensure the integrity of the application layer messages (i.e., the payload of the forwarded messages) or ensure the integrity of the added header information.

Regardless of exactly how the intermediate node 18 obtains header information for the WD 12, the intermediate node 18 may specifically map that header information to the WD 12 in order to ensure proper forwarding of messages for that WD 12. For example, the intermediate node 18 may map the header information to a unique identifier of the WD 12. In some embodiments, this at least entails mapping PDP addresses of the WD 12 and AS 14 to a unique identifier of the WD 12. Thereafter, the intermediate node 18 receives an application layer message from the WD along with the unique identifier of the WD 12, and identifies the PDP addresses of the WD 12 and AS 14 by identifying the addresses mapped to the received identifier. The intermediate node 18 then adds header information for the one or more particular layers that includes the identified addresses as source and destination PDP addresses (whether a particular PDP address is included as source or destination depends on the direction in which the message is being forwarded).

In this regard, the unique identifier of the WD 12 may directly or indirectly indicate the PDP context with which an application layer message is associated (since the PDP context may include the PDP address of the WD 12). The unique identifier may also indicate whether or not that PDP context supports the first protocol stack. In this case, the intermediate node 18 determines whether or not each application layer message received is associated with a PDP context that supports the first protocol stack based on the unique identifier received along with the application layer message.

In other embodiments, an identifier specific to the PDP context for the WD 12 identifies the PDP context as supporting the first protocol stack. For instance, the intermediate node 18 may assign PDP contexts it activates an identifier. In doing so, the intermediate node 18 assigns PDP contexts that support the first protocol stack (as indicated by the corresponding PDP context activation requests) an identifier from a set of reserved PDP context identifiers. These PDP context identifiers are reserved in the sense that only those PDP contexts that support the first protocol stack are assigned such an identifier.

Thus, in these embodiments, the WD 12 sends the PDP context identifier along with an application layer message that it sends to the intermediate node 18. The intermediate node 18 examines each application layer message and corresponding PDP context identifier received to determine whether or not the message is associated with a PDP context that supports the first protocol stack. The intermediate node 18 determines that a message is associated with such a PDP context if the message is received along with one of the reserved PDP context identifiers.

The above described embodiments prove particularly advantageous in the case that the WD 12 is a Machine Type Communication (MTC) device. As an MTC device, the WD 12 executes an application (referred to as a machine application) that sends application layer messages to an application server with little or no human intervention. The application layer messages may, for instance, comprise data payloads for smart utility metering, inventory control, remote patient care, etc. Typically, these data payloads are sent to the same AS 14 for as long as the corresponding PDP context remains activated, meaning that much of the header information describing the data payloads, their destination, and the like will remain static; only the length of the data payloads and any error detection fields will vary between successive payloads.

The embodiments exploit this fact by having the WD 12 exclude such header information when sending application layer messages to the AS 14 and having an intermediate node 18 with prior knowledge of the header information add that information before forwarding the messages to the AS 14. Since the header information does not traverse the entire wireless communication system 10, the embodiments conserve scarce communication resources (e.g., those associated with the radio interface). Moreover, because the header information remains substantially static, the embodiments suffer little, if any, performance degradation.

Other embodiments herein prove advantageous for MTC devices in other respects. Typically, data payloads sent to or from MTC devices are relatively small (e.g., 12 octets or less) and as recognized herein can be supported using default PDP context attributes. Some embodiments thus exploit this characteristic to simplify the PDP context activation process, and thereby reduce the amount of control signaling associated with PDP context activation and reduce the memory requirements for storing PDP contexts.

In one or more of such embodiments, for instance, the intermediate node 18 in forwarding application layer messages applies default quality of service (QoS) attributes predefined for nodes using the first protocol stack. The default QoS attributes may define basic priority and delay attributes for such messages. Regardless, applying default QoS attributes simplifies PDP context activation because those QoS attributes no longer need be signaled from the WD 12 to the intermediate node 18 or maintained in the PDP context at the intermediate node 18. Such translates into reduced control signaling and reduced memory requirements for PDP context activation.

The intermediate node 18 may further simplify the PDP context activation process by applying default ciphering parameters and/or default compression parameters. In such embodiments, the WD 12 includes in the PDP context activation request a request to use ciphering and/or compression for the activated PDP context. Responsive to this request, the intermediate node 18 applies default ciphering parameters and/or default compression parameters for transmitting application layer messages between the WD 12 and the intermediate node 18 in accordance with the first protocol stack.

Embodiments will now be described in the context of a concrete example where the wireless communication system 10 comprises an Enhanced General Packet Radio Services (EGPRS) system and the one or more layers excluded from the first protocol stack comprise the User Datagram Protocol (UDP) and Internet Protocol (IP) layers, or UDP/IP. EGPRS is a third generation (3G) digital wireless communication technology that provides increased data transmission rates and improved data transmission reliability over the GPRS standard. EGPRS is a digital, packet-switched service available to users of the Global System for Mobile Communications (GSM) wireless standard.

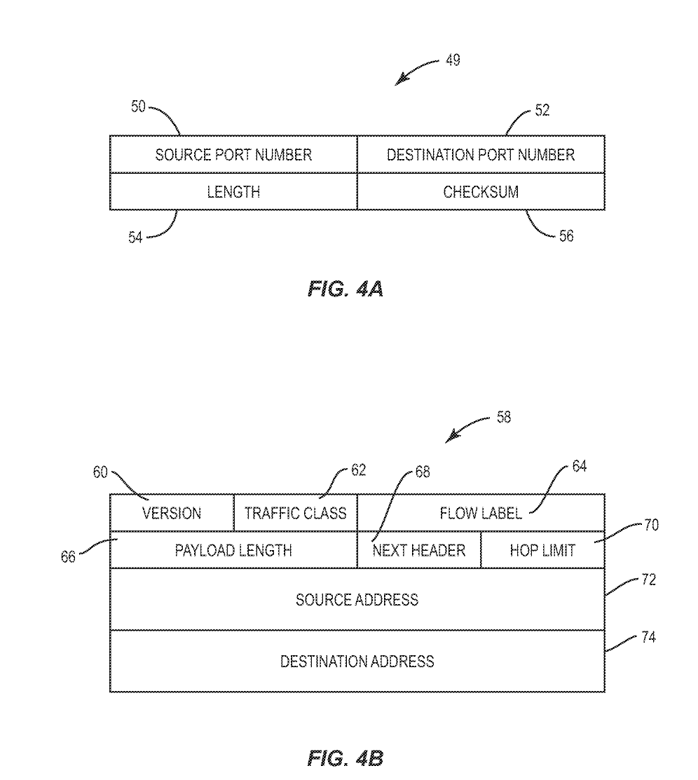

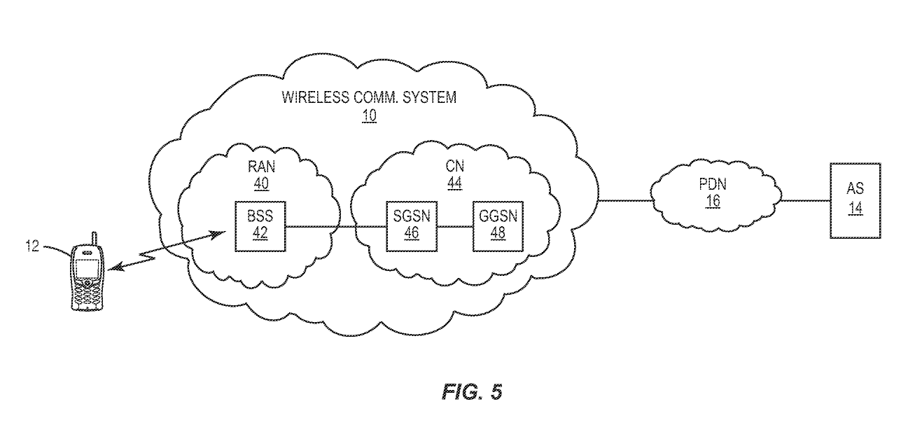

UDP is a minimal message-oriented Transport Layer protocol. It provides no guarantees to upper layers for message delivery and retains no state of UDP messages once sent. A UDP header 49, as shown in FIG. 4A, consists of four fields: source port number 50, destination port number 52, length 54, and checksum 56. Each field in this example is 2 bytes, meaning that the entire UDP header 49 is 8 bytes.

The source port number field 50 identifies the sender's port while the destination port number field 52 identifies the receiver's port. The length field 54 specifies the length of the entire UDP datagram, including header and data. The minimum length is 8 bytes, since that's the length of the header, while the theoretical maximum length set by the size of the length field 54 is 65,535 bytes. The checksum field 56 is used for error-checking of the header and data. According to embodiments herein, the source port number field 50 and the destination port number field 52 remain static for the duration of a PDP context, while the length field 54 and the checksum field 56 dynamically vary from message to message.

An IP header 58 on the other hand, at least according to IP version 6, is shown in FIG. 4B. The IP header 58 consists of eight fields: version 60, traffic class 62, flow label 64, payload length 66, next header 68, hop limit 70, source address 72, and destination address 74.

The version field 60 in this example is a 4-bit field containing the number 6 for indicating that the IP version in use is 6. The traffic class field 62 is an 8-bit field that can assume different values for indicating that different IP datagrams have different delivery priorities. The flow label field 64 is set to indicate which, if any, active flow the IP datagram belong to (non-zero values indicate a particular flow, while a value of 0 indicates no flow). The payload length field 66 is a 16-bit field that contains the length of the data following the IP header 58 (i.e., the length of the UDP header 49 plus the application layer message length). The next header field 68 is an 8-bit field that identifies the type of header immediately following the IP header and located at the beginning of the data (e.g., a transport layer protocol such as UDP). The hop limit field 70 is an 8-bit field that indicates the maximum number of hops an IP packet can make before being discarded, and is thus decremented by one at each hop. The source address field 22 indicates the IP address of the sender, while the destination address field 74 indicates the IP address of the receiver.

According to embodiments herein, the version field 60, the traffic class field 62, the flow label field 64, the next header field 68, the hop limit field 70, the source address field 72, and the destination address field 74 will each remain static for the duration of a PDP context. Thus, only the payload length field 66 will vary from message to message.

Turning now to the details of an EGPRS wireless communication system 10, FIG. 5 illustrates that such a system 10 comprises a radio access network (RAN) 40 that includes a base station subsystem (BSS) 42 and a core network (CN) 44 that includes a serving GPRS support node (SGSN) 46 and a gateway GPRS support node (GGSN) 48. The BSS 42 in the RAN 40 provides the WD 12 with access to the CN 44 over radio resources. The CN 44 correspondingly connects the RAN 40 to the AS 14, via the PDN 16. In this regard, the SGSN 46 performs session management and GPRS mobility management, such as handovers and paging. The GGSN 48 provides a gateway between the CN 44 and the PDN 16, and may also implement authentication and location management functions.

In relevant part, the WD 12 communicates with the AS 14 at the highest protocol layer, the application layer. The WD 12 communicates with the SGSN 46 at the Logical Link Control (LLC) layer, which provides a logical connection between the WD 12 and the SGSN 46. Finally, the WD 12 communicates with the BSS 42 at the radio layer. In between the radio layer and the LLC layer are the Radio Link Control (RLC) layer and the Medium Access Control (MAC) layer.

A temporary block flow (TBF) in this context is a physical connection that supports the unidirectional transfer of LLC PDUs on one or more physical channels (e.g., Packet Data Channels, PDCHs). A TBF is temporary and is maintained only for as long as necessary to transmit an application layer message.

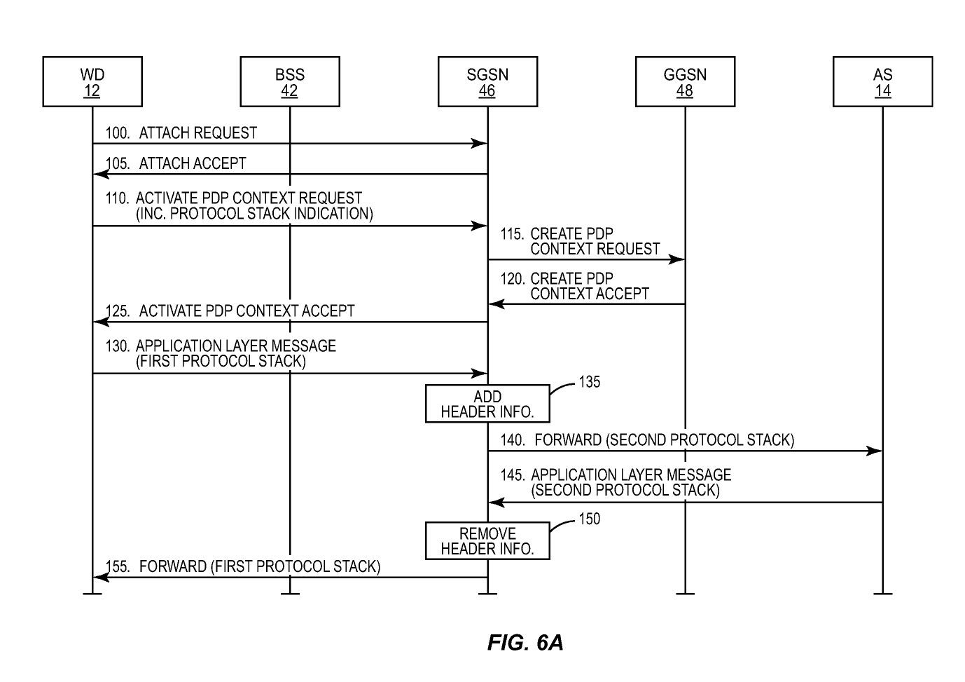

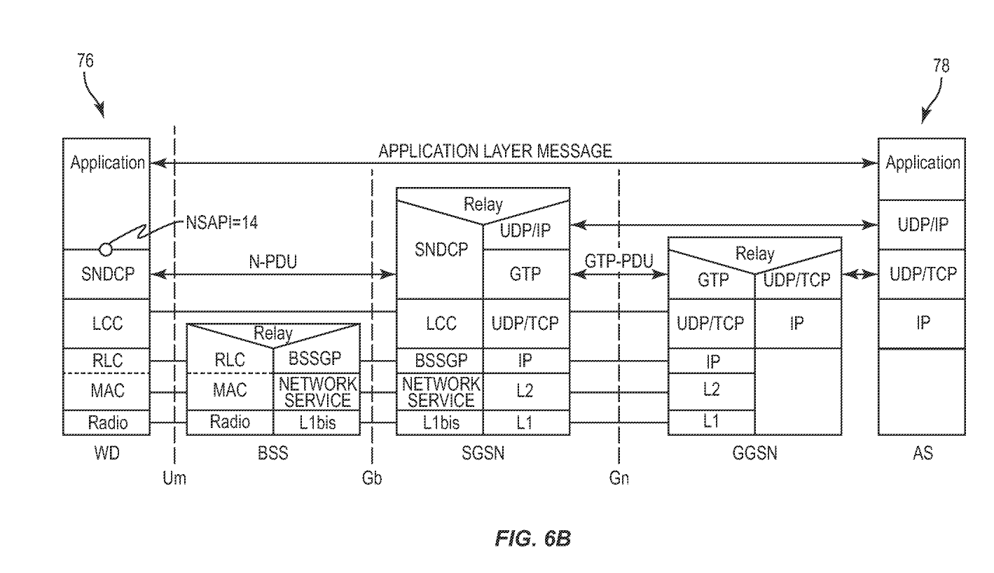

FIG. 6A illustrates one or more EGPRS embodiments where the SGSN 46 serves as the intermediate node 18 discussed above. As shown in FIG. 6A, the WD 12 may first attach to the CN 44 by sending a GPRS Attach Request to the SGSN 46 (Step 100). Responsive to receiving a GPRS Attach Accept response from the SGSN 46 (Step 110), the WD 12 may move from an Idle state to a Ready state, where in the Ready state the WD 12 is in a position to initiate a PDP context.

In this regard, the WD 12 generates and sends an Activate PDP Context Request to the SGSN 46 (Step 110), requesting that the SGSN 46 activate a PDP context for supporting routing of application layer messages via the SGSN 46. The Request includes the Access Point Name (APN) associated with the GGSN 48 to be used. The WD 12 generates the Activate PDP Context Request to also indicate that the WD 12 is capable of using a first protocol stack that excludes the UDP/IP layers included in a second protocol stack used by the AS 14. Moreover, in some embodiments, the WD 12 proactively generates the Activate PDP Context Request to include certain header information for these UDP/IP layers. Such header information may include the destination address field 74 for the IP header 58 (i.e. associated with the AS 14), as well as the source port number field 50 and the destination port number field 52 for the UDP header 49.

The SGSN 46 receives this request and sends a corresponding Create PDP Context Request to the GGSN 48 (Step 115). The SGSN 46 in at least some embodiments includes in this Request an indication that a long-lived IP address is desired for the WD 12, so that the GGSN 48 can allocate an IP address to the WD 12 that can remain static for days, weeks, months, etc. Regardless, the GGSN 48 dynamically allocates an IP address to the WD 12 and returns that address to the SGSN 46 in a Create PDP Context Accept (Step 120). The SGSN 46 then activates the requested PDP context by creating a data structure at the SGSN 46 that includes, among other things, the IP address just allocated to the WD 12. The SGSN 46 assigns an identifier to this PDP context, referred to as a packet flow identifier (PFI). In some embodiments, the SGSN 46 assigns the PDP context a PFI from a set of PFIs reserved for identifying PDP contexts that support the first protocol stack (and thereby exclude the UDP/IP layers).

The SGSN 46 finally concludes the PDP context activation process by responding to the WD 12 with an Activate PDP Context Accept (Step 125), which includes the IP address allocated to the WD 12 as well as the PFI of the activated PDP context. The SGSN 46 also indicates in the Activate PDP Context Accept that the SGSN 46 will support the WD's use of the first protocol stack by forwarding application layer messages destined for the WD 12 in accordance with the first protocol stack (without the UDP/IP layers) and forwarding application layer messages destined for the AS 14 in accordance with the first protocol stack (with the UDP/IP layers). In embodiments where the WD 12 does not proactively include certain header information for the UDP/IP layers in the Activate PDP Context Request, the SGSN 46 includes a request for such header information in the Activate PDP Context Accept.

Once the PDP Context activation procedure has been completed and the corresponding UPD/IP header information provided to the SGSN 46, radio resource establishment procedures (e.g., TBF establishment procedures) commence for sending application layer messages between the WD 12 and the AS 14. As part of this process (not shown), the WD 12 sends a request to the BSS 42 (e.g., an EGPRS Packet Channel Request) requesting that the BSS 42 allocate the WD 12 radio resources. In doing so, the WD 12 conveys to the BSS 42 the PFI of the PDP context for which radio resources are being established. In at least one embodiment, the BSS 42 has knowledge of the set of PFIs reserved for identifying PDP contexts that support the first protocol stack, and can thus identify whether the radio resources are being established for such a PDP context. In other embodiments, the WD 12 includes in the radio resource request an indicator that directly or indirectly indicates that radio resources are being established for a PDP context that supports the first protocol stack.

Regardless of exactly how the BSS 42 determines that the radio resources are being established for such a PDP context, the BSS 42 in at least some embodiments grants radio resources based on default QoS attributes applicable for PDP contexts that support the first protocol stack. The BSS 42 may also command the WD 12 to use a default coding and modulation scheme for such PDP contexts. By applying default QoS attributes, in particular, the BSS 42 need not query the SGSN 46 for the specific QoS of the PDP context. This of course reduces control signaling requirements as compared to legacy operation.

With the PDP context activated and the radio resources for that PDP context established, the WD 12 transmits an application layer message supported by that PDP context toward the SGSN 46 using the first protocol stack (Step 130). As shown in FIG. 6B, this first protocol stack 76 includes (from higher to lower layers) the application layer, a Sub Network Dependent Convergence Protocol (SNDCP) layer, the LLC layer, the RLC layer, the MAC layer, and the radio layer. Notably, the first protocol stack 76 excludes the UDP/IP layers, despite the WD 12 actually having the header information for those layers. Thus, the application layer message is encapsulated directly within an SNDCP PDU, not within an UDP/IP PDU as in legacy approaches. The SNDCP PDU is of course in turn encapsulated within an LLC PDU.

The BSS 42 receives this LLC PDU and forwards it to the SGSN 46. The SGSN 46 correspondingly receives the LLC PDU and recovers the application layer message. In doing so, the SGSN 46 identifies the PDP context over which the application layer message was sent as supporting the first protocol stack (e.g., by identifying the PFI of the PDP context as being a reserved PFI). The SGSN 46 then identifies the static UDP/IP header information previously obtained and still maintained for that PDP context, including the source port number field 50 and the destination port number field 52 for the UDP header 49 and the version field 60, the traffic class field 62, the flow label field 64, the next header field 68, the hop limit field 70, the source address field 72, and the destination address field 74 for the IP header 58. The SGSN 46 also calculates certain dynamic UDP/IP header information based on the actual application layer message received, including the length field 54 and the checksum field 56 of the UDP header 49 and the payload length field 66 of the IP header 58. Using this UDP/IP header information, the SGSN 46 generates the UDP/IP layers and adds those layers to the application layer message (Step 135). With the UDP/IP layers added, the SGSN 46 forwards the message to the AS 14 in accordance with the second protocol stack 78 (Step 140). The GGSN 48 relays the message to the AS 14 using the GPRS Tunneling Protocol (GTP).

In the opposite direction, the AS 14 likewise sends an application layer message to the SGSN 46 using the second protocol stack 78 (Step 145). As shown in FIG. 6B, the second protocol stack 78 includes (from higher layer to lower layer) the application layer, the UDP/IP layers, the UDP/TCP layers, and the IP layer. Thus, the application layer message is encapsulated directly within an UDP/IP PDU. However, when the SGSN 46 receives the message, it removes the header information for the UDP/IP layers (Step 150) in order to forward the message to the WD 12 in accordance with the first protocol stack (Step 155).

Those skilled in the art will of course appreciate that the above embodiments have been described as non-limiting examples, and have been simplified in many respects for ease of illustration. For instance, the embodiments in FIGS. 6A-6B have conveniently omitted ciphering and compression details. As already suggested, though, default ciphering parameters and/or default compression parameters may be applied in order to simplify the PDP context activation process and thereby reduce the amount of control signaling. In this case, the legacy eXchange IDentities (XID) process for negotiation of ciphering and compression parameters need not occur as a distinct signaling activity after completion of the PDP context activation procedure. Instead, responsive to the WD's Activate PDP Context Request (Step 210), the SGSN 46 notifies the LLC and SNDCP protocol entities in the SGSN 46 that default ciphering and compression parameters for PDP contexts that support the first protocol stack are to be applied. Such default parameters, in some embodiments, include a PCOMP value of 0 for SNDCP operation, meaning that no header or data compression is to be used. The default parameters further specify that information transfer will be unacknowledged at the LLC layer; thus, only LLC Unnumbered Information (UI) frames are to be used. Also, the default parameters may indicate an N201-U value of 140 for the maximum LLC PDU size, at least for embodiments where the data payloads are relatively small. Finally, the default parameters include an Input Offset Value (IOV) for UI frames, as determined by the SGSN 46. The WD 12 correspondingly applies these default parameters, with the only parameter needing to be signaled to the WD 12 being the IOV-UI value for ciphering. Thus, in some embodiments, the SGSN 46 responds to the WD's Activate PDP Context Request with an Activate PDP Context Accept that includes the IOV-IU value (Step 225).

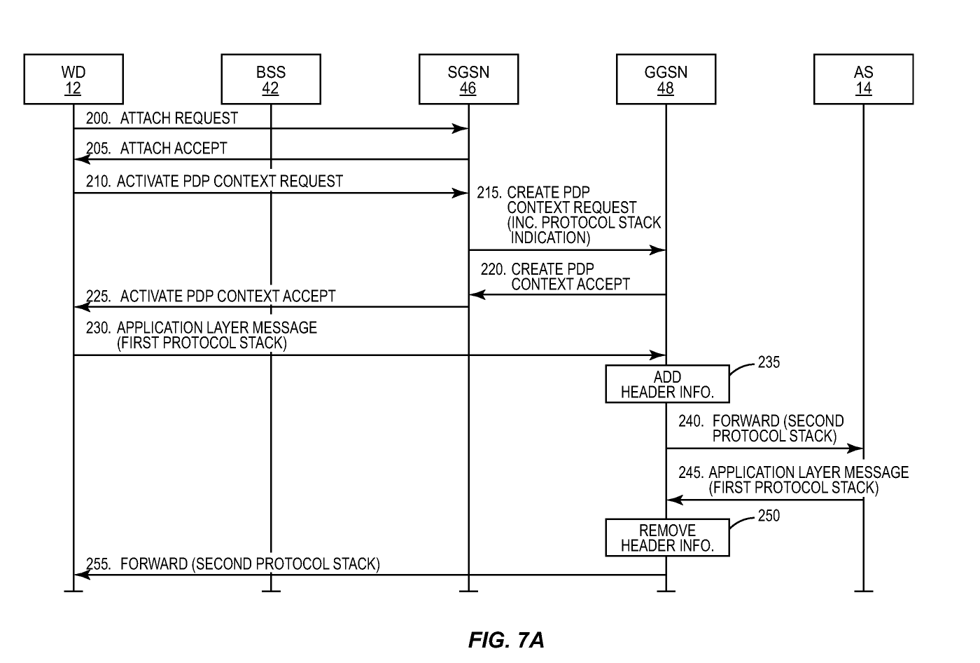

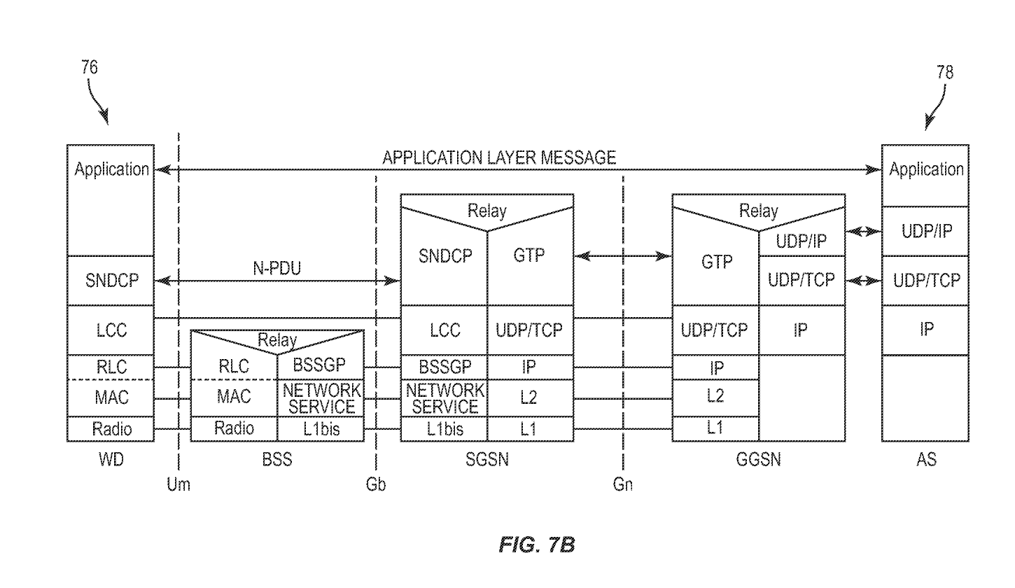

Those skilled in the art will also appreciate that nodes in the system 10 other than the SGSN 46 may serve as the intermediate node 18 discussed above. In at least one embodiment, for instance, the GGSN 48 rather than the SGSN 46 serves as the intermediate node 18. FIGS. 7A and 7B illustrate this case.

As shown in FIGS. 7A and 7B, attachment procedures (Steps 200 and 205) proceed as before, and the SGSN 46 still receives an Activate PDP Context Request from the WD 12 that indicates the WD 12 is capable of using the first protocol stack and that may include UDP/IP header information (Step 210). However, in these embodiments, the SGSN 46 relays the indication and any UDP/IP header information to the GGSN 48 in the Create PDP Context Request (Step 215). The GGSN 48 responds in the Create PDP Context Accept (Step 220) that it will support the WD″s use of the first protocol stack by forwarding application layer messages toward the WD 12 in accordance with the first protocol stack and forwarding application layer messages towards the AS 14 in accordance with the second protocol stack. The SGSN 46 correspondingly relays this to the WD 12 in the Activate PDP Context Accept (Step 225).

Thereafter, the GGSN 48 rather than the SGSN 46 is the node that adds (Step 235) and removes (Step 250) the UDP/IP layers, and is the node that maintains header information for those layers. FIG. 7B thus illustrates that the UDP/IP layer is implemented at the GGSN 48 rather than the SGSN 46. The SGSN 46 need not maintain or even receive that header information, but simply relays the request for and acceptance of the WD's use of the first protocol stack to and from the GGSN 48.

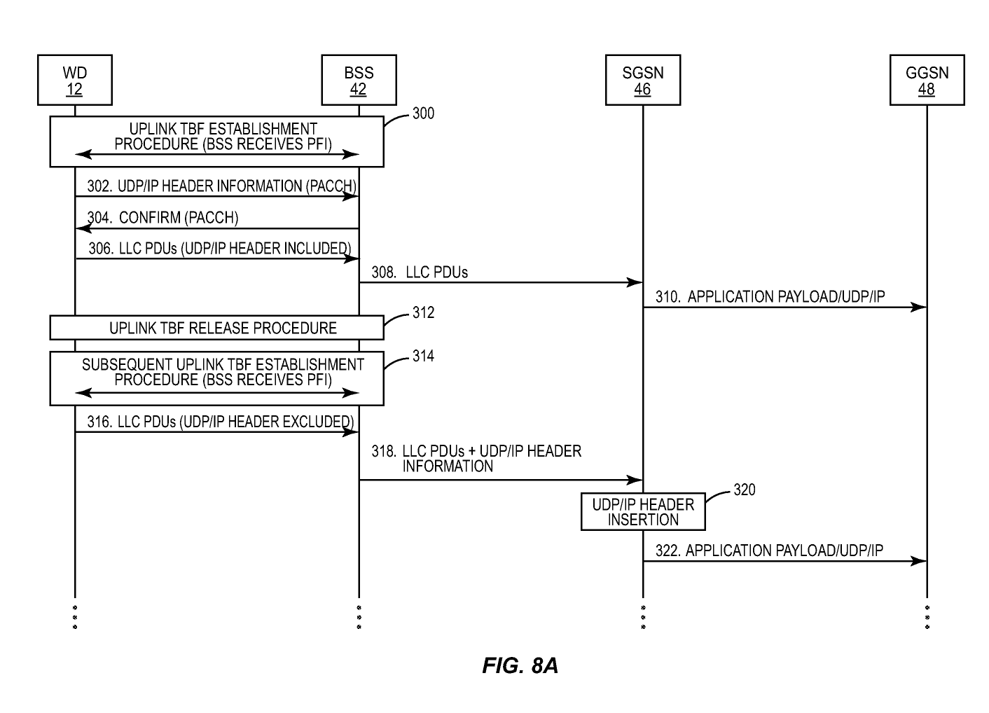

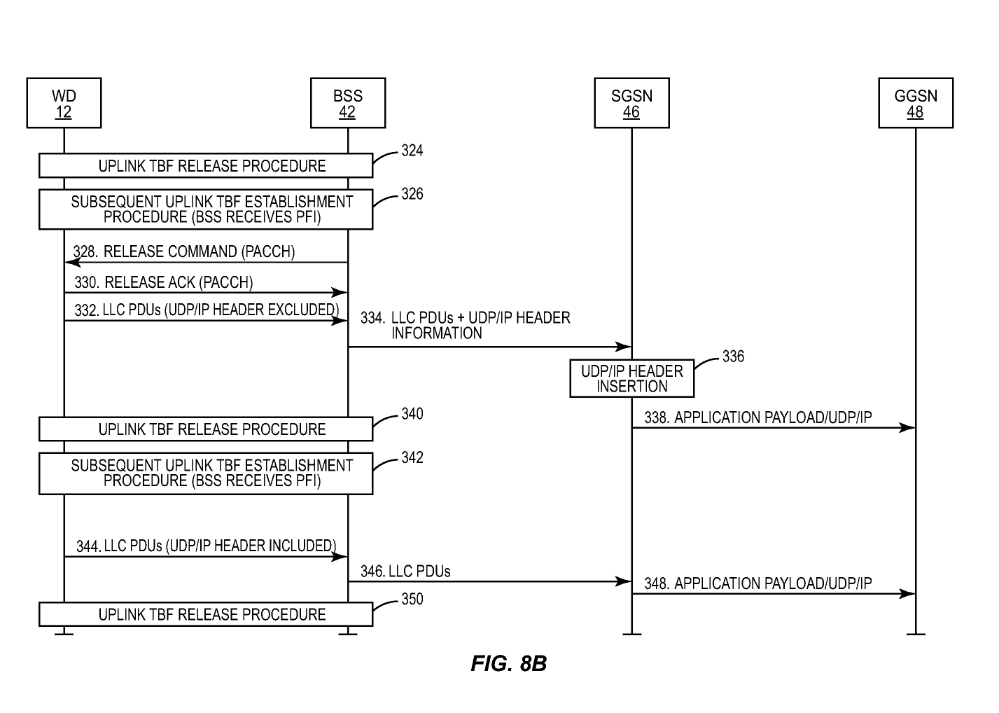

Those skilled in the art will further appreciate that the BSS 42 may be involved with relaying of the UDP/IP header information to the SGSN 46 and/or GGSN 48 as well. Consider FIG. 8A and FIG. 8B. In FIG. 8A, the BSS 42 establishes an uplink TBF with the WD 12 and, in doing so, receives the PFI of the corresponding PDP context (Step 300). Thereafter, the BSS 42 receives the associated UDP/IP header information over a packet associated control channel (PACCH) (Step 302) and confirms such receipt (Step 304). When the BSS 42 receives LLC PDUs from the WD 12 over the TBF used to send the UDP/IP header information (Step 306), those LLC PDUs already include the UDP/IP header information (that is, the WD 12 does not yet use the first protocol stack). The BSS 42 simply relays the LLC PDUs to the SGSN 46 (Step 308), which likewise relays the associated application layer message to the GGSN 48 (without adding UDP/IP header information of course, since the WD 12 already included that information).

After that TBF is released (Step 312), however, the WD 12 uses the first protocol stack when sending application layer messages over TBFs subsequently established for the PDP context. Thus, after the BSS 42 next establishes an uplink TBF with the WD 12 (Step 314), the BSS 42 receives from the WD 12 over that TBF LLC PDUs that exclude the UDP/IP header information (that is, the WD 12 does use the first protocol stack) (Step 315). Upon the BSS 42 receiving an LLC PDU associated with a PFI for which it has corresponding UDP/IP header information, the BSS 42 sends the LLC PDU and the UDP/IP header information to the SGSN 46 (Step 318). As discussed above, the SGSN 46 adds the UDP/IP header information and forwards the associated application layer message towards the AS 14 (via the GGSN) in accordance with the second protocol stack (Step 322). Note that the SGSN's reception of the UDP/IP header information, in conjunction with an LLC PDU, implicitly indicates to the SGSN 46 that the associated application layer message was sent using the first protocol stack.

Discontinuing use of the first protocol stack proceeds in an analogous manner to establishing such use. Transitions between including and excluding UDP/IP header information therefore occur on a TBF basis. As shown in FIG. 8B, for instance, after the TBF above is released (Step 324) and another TBF established (Step 326), the BSS 42 sends a release command to the WD 12, commanding the WD 12 to discontinue use of the first protocol stack when sending application layer messages over subsequently established TBFs (Step 328). The WD 12 acknowledges the command (Step 330), and continues to use the first protocol stack (Steps 332-340) until the next TBF is established (Steps 342-350).

Note that the PACCH signaling cost associated with the BSS 42 requesting and receiving the UDP/IP header information will be more than compensated for by the repeated overhead savings realized through use of the first protocol stack. Indeed, the overhead savings may be as much as 46-48 octets per application layer message.

Those skilled in the art will also appreciate that while the above discussion was limited to a single PDP context for a single application at the WD 12, embodiments herein recognize that the WD 12 may be configured to establish different PDP contexts for different applications. Thus, the WD 12 may be configured to use the first protocol stack for sending application layer messages of one application, but not another. In this case, different PDP context identifiers (i.e., PFIs) distinguish between the different PDP contexts associated with a given WD 12 and the corresponding different protocol stacks employed for each.

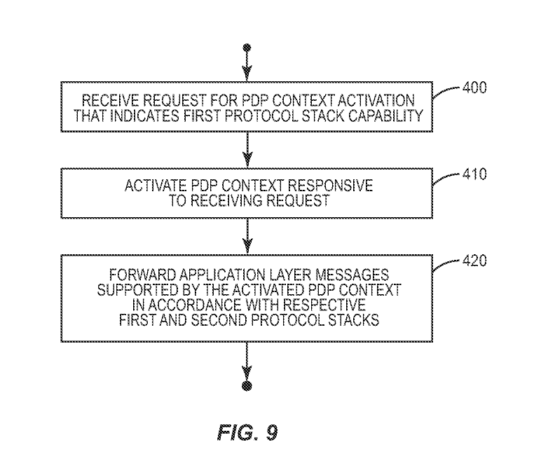

With the above variations and modifications in mind, those skilled in the art will appreciate that an intermediate node 18 herein (e.g., an SGSN 46 or GGSN 48 in EGPRS embodiments) is generally configured to perform the processing illustrated in FIG. 9. In FIG. 9, processing includes receiving a request to activate a PDP context for the WD 12 (Block 400). The request indicates the WD 12 is capable of using a first protocol stack that excludes one or more particular layers included in a second protocol stack used by the AS 14. Processing further includes activating a PDP context for the WD 12 in accordance with the request (Block 410). The resulting activated PDP context supports routing of application layer messages via the intermediate node 18. Finally, processing includes forwarding application layer messages supported by the activated PDP context between the WD 12 and the AS 14, forwarding application layer messages destined for the WD 12 in accordance with the first protocol stack and forwarding application layer messages destined for the AS 14 in accordance with the second protocol stack (Block 420).

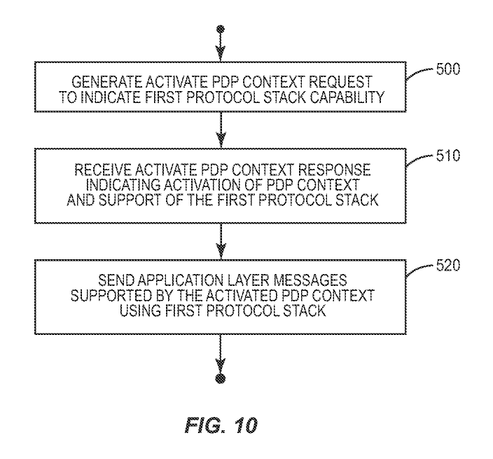

Those skilled in the art will appreciate that the WD 12 is correspondingly configured to perform the processing illustrated in FIG. 10. In FIG. 10, processing includes generating a request requesting that the intermediate node 18 activate a PDP context for supporting routing of application layer messages via the intermediate node 18 (Block 500). This request also indicates that the WD 12 is capable of using a first protocol stack that excludes one or more particular layers included in a second protocol stack used by the AS 14. Processing also includes receiving a response from the intermediate node 18 indicating that the intermediate node 18 has activated the requested PDP context and will support the WD's use of the first protocol stack by forwarding application layer messages destined for the WD 12 in accordance with the first protocol stack and forwarding application layer messages destined for the AS 14 in accordance with the second protocol stack (Block 510). Finally, processing includes sending application layer messages supported by the activated PDP context toward the intermediate node 18 using the first protocol stack (Block 520).

Those skilled in the art will also appreciate that the various “circuits” described may refer to a combination of analog and digital circuits, including one or more processors configured with software stored in memory 30 and/or firmware stored in memory 30 that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method implemented by an intermediate node for wirelessly transmitting application layer messages between a first node and a second node, comprising:
receiving a request to activate a packet data protocol (PDP) context for the first node, the request generated by the first node and indicating the first node is capable of using a first protocol stack that excludes one or more particular layers included in a second protocol stack used by the second node;
activating a PDP context for the first node in accordance with the request, the resulting activated PDP context supporting routing of application layer messages via the intermediate node; and
forwarding application layer messages supported by the activated PDP context between the first node and the second node, forwarding application layer messages destined for the first node in accordance with the first protocol stack and forwarding application layer messages destined for the second node in accordance with the second protocol stack.

2. The method of claim 1, wherein said one or more particular layers comprise the User Datagram Protocol (UDP) and Internet Protocol (IP) layers.

3. The method of claim 1, wherein the request includes header information for said one or more particular layers, wherein the method further comprises generating said one or more particular layers from that header information; and wherein said forwarding comprises forwarding application layer messages that are supported by the activated PDP context and that are destined for the second node by adding the one or more generated layers to those messages

4. The method of claim 1, further comprising:
responding to the request for PDP context activation by sending a request to the first node for header information for said one or more particular layers;
receiving the requested header information from the first node;
generating said one or more particular layers from the requested header information; and
forwarding application layer messages that are supported by the activated PDP context and that are destined for the second node by adding the one or more generated layers to those messages.

5. The method of claim 1, wherein forwarding application layer messages destined for the second node comprises adding header information for said one or more particular layers that is dynamically determined at the intermediate node and that is associated with at least one of:
a length of the application layer messages; and
error detection for said one or more particular layers.

6. The method of claim 1, further comprising mapping addresses of the first and second nodes to a unique identifier of the first node, and wherein said forwarding comprises receiving an application layer message from the first node along with the unique identifier of that first node, identifying the addresses of the first and second nodes by identifying the addresses mapped to that unique identifier, and adding header information for said one or more particular layers that includes the identified addresses as source and destination addresses.

7. The method of claim 1, further comprising examining each application layer message received to determine whether or not the message is associated with a PDP context that supports the first protocol stack, determining that the message is associated with such a PDP context if the message is received along with one of a plurality of reserved PDP context identifiers.

8. The method of claim 1, further comprising determining whether or not each application layer message received is associated with a PDP context that supports the first protocol stack, determining that the message is associated with such a PDP context based on a unique identifier that is received along with the message and that uniquely identifies the node from which the message was received.

9. The method of claim 1, wherein the request also requests use of at least one of ciphering and compression for the activated PDP context, and wherein the method further comprises applying at least one of default ciphering parameters and default compression parameters predefined for transmitting application layer messages between the first node and the intermediate node using the first protocol stack.

10. The method of claim 1, wherein said forwarding comprises applying default quality of service attributes predefined for nodes using the first protocol stack.

11. An intermediate node for wirelessly transmitting application layer messages between a first node and a second node, comprising:
a packet data protocol (PDP) context controller configured to:
receive a request to activate a packet data protocol (PDP) context for the first node, the request generated by the first node and indicating the first node is capable of using a first protocol stack that excludes one or more particular layers included in a second protocol stack used by the second node; and
activate a PDP context for the first node in accordance with the request, the resulting activated PDP context supporting routing of application layer messages via the intermediate node; and
a forwarding circuit configured to forward application layer messages supported by the activated PDP context between the first node and the second node, forwarding application layer messages destined for the first node in accordance with the first protocol stack and forwarding application layer messages destined for the second node in accordance with the second protocol stack.

12. The intermediate node of claim 11, wherein said one or more particular layers comprise the User Datagram Protocol (UDP) and Internet Protocol (IP) layers.

13. The intermediate node of claim 11, wherein the request includes header information for said one or more particular layers, and wherein the forwarding circuit is configured to generate said one or more particular layers from that header information and to forward application layer messages that are supported by the activated PDP context and that are destined for the second node by adding the one or more generated layers to those messages.

14. The intermediate node of claim 11, wherein the PDP context controller is configured to respond to the request for PDP context activation by sending a request to the first node for header information for said one or more particular layers, and to receive the requested header information from the first node, and wherein the forwarding circuit is configured to generate said one or more particular layers from the requested header information and to forward application layer messages that are supported by the activated PDP context and that are destined for the second node by adding the one or more generated layers to those messages.

15. The intermediate node of claim 11, wherein the PDP context controller is configured to map addresses of the first and second nodes to a unique identifier of the first node, and wherein the forwarding circuit is configured to receive an application layer message from the first node along with the unique identifier of that first node, identify the addresses of the first and second nodes by identifying the addresses mapped to that unique identifier, and add header information for said one or more particular layers that includes the identified addresses as source and destination addresses.

16. The intermediate node of claim 11, wherein the forwarding circuit is configured to forward application layer messages that are supported by the activated PDP context and that are destined for the second node by adding header information for said one or more particular layers that is dynamically determined at the intermediate node and that is associated with at least one of:
a length of the application layer messages; and
error detection for said one or more particular layers.

17. The intermediate node of claim 11, wherein the forwarding circuit is configured to examine each application layer message received from the first node to determine whether the message is associated with a PDP context that supports the first protocol stack, determining that the message is associated with such a PDP context if the message includes one of a plurality of reserved PDP context identifiers.

18. The intermediate node of claim 11, wherein the forwarding circuit is configured to determine whether or not each application layer message received is associated with a PDP context that supports the first protocol stack, determining that the message is associated with such a PDP context based on a unique identifier that is received along with the message and that uniquely identifies the node from which the message was received.

19. The intermediate node of claim 11, wherein the request also requests use of at least one of ciphering and compression for the activated PDP context, and wherein the forwarding circuit is configured to apply at least one of default ciphering parameters and default compression parameters predefined for transmitting application layer messages between the first node and the intermediate node using the first protocol stack.

20. The intermediate node of claim 11, wherein the forwarding circuit is configured to apply default quality of service attributes predefined for nodes using the first protocol stack.

21. A method implemented by a first node for transmitting application layer messages to a second node, comprising:
generating a request requesting that an intermediate node activate a packet data protocol (PDP) context for supporting routing of application layer messages via the intermediate node and indicating that the first node is capable of using a first protocol stack that excludes one or more particular layers included in a second protocol stack used by the second node;
receiving a response from the intermediate node indicating that the intermediate node has activated the requested PDP context and will support the first node's use of the first protocol stack by forwarding application layer messages destined for the first node in accordance with the first protocol stack and forwarding application layer messages destined for the second node in accordance with the second protocol stack; and
sending application layer messages supported by the activated PDP context toward the intermediate node using the first protocol stack.

22. The method of claim 21, wherein said one or more particular layers comprise the User Datagram Protocol (UDP) and Internet Protocol (IP) layers.

23. The method of claim 21, wherein the request also requests use of at least one of ciphering and compression for the activated PDP context, and wherein the method further comprises applying at least one of default ciphering parameters and default compression parameters predefined for transmitting application layer messages using the first protocol stack.

24. The method of claim 21, wherein said receiving comprises receiving a response from the intermediate node that requests the first node send header information for said one or more particular layers and wherein the method further comprises sending said header information toward the intermediate node.

25. The method of claim 21, wherein said generating comprises including header information for said one or more particular layers in the request.

26. A first node configured to transmit application layer messages to a second node, comprising:
a PDP context controller configured to:
generate a request requesting that an intermediate node activate a packet data protocol (PDP) context for supporting routing of application layer messages via the intermediate node and indicating that the first node is capable of using a first protocol stack that excludes one or more particular layers included in a second protocol stack used by the second node;
receive a response from the intermediate node indicating that the intermediate node has activated the requested PDP context and will support the first node's use of the first protocol stack by forwarding application layer messages destined for the first node in accordance with the first protocol stack and forwarding application layer messages destined for the second node in accordance with the second protocol stack; and
a transmission circuit configured to send application layer messages supported by the activated PDP context toward the intermediate node using the first protocol stack.

27. The first node of claim 26, wherein said one or more particular layers comprise the User Datagram Protocol (UDP) and Internet Protocol (IP) layers.

28. The first node of claim 26, wherein the request also requests use of at least one of ciphering and compression for the activated PDP context, and wherein the transmission circuit is configured to apply at least one of default ciphering parameters and default compression parameters predefined for transmitting application layer messages using the first protocol stack.

29. The first node of claim 26, wherein the PDP context controller is configured to receive a response from the intermediate node that requests the first node send header information for said one or more particular layers and wherein the transmission circuit is configured to send said header information toward the intermediate node.

30. The first node of claim 26, wherein the PDP context controller is configured to include header information for said one or more particular layers in the request.
